(19) United States
(12) Patent Application Publication
(10) Pub. No.: US 2007/0280488 A1
(43) Pub. Date: Dec. 6, 2007

(54) ELECTRONIC APPARATUS WITH EARPHONES ALSO CAPABLE OF SERVING AS SPEAKERS

(76) Inventor: Kuo Chia-Hung, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/756,734

(22) Filed: Jun. 1, 2007

(30) Foreign Application Priority Data
Jun. 1, 2006 (TW) 095119409

(51) Int. Cl. H04B 15/00

(52) U.S. Cl. 381/94.3

(57) ABSTRACT

The invention provides an electronic apparatus. The electronic apparatus includes a casing, an electronic unit, a cable-winding device, a first speaker, and a second speaker. The first speaker is electrically coupled to the electronic unit by a first cable. The second speaker is electrically coupled to the electronic unit by a second cable. When the first speaker and the second speaker are respectively associated with a first recess and a second recess, the first cable and the second cable are wound back in the cable-winding device, and the electronic unit is capable of broadcasting an audio signal at a first power via the first speaker and the second speaker; when the first speaker and the second speaker are pulled out of the casing, the electronic unit is capable of broadcasting the audio signal at a second power via the first speaker and the second speaker.

### BACKGROUND OF THE INVENTION

1. Field of the Invention

The present invention relates to an electronic apparatus providing a double-duty speaker for an earphone or a common speaker.

2. Description of the Prior Art

Most electronic apparatuses with an earphone or a speaker are mainly communication apparatus at present, such as cellular phones. A common cellular phone broadcasts audio signals by a speaker thereof or an external earphone. However, it is inconvenient to use. For example, when a user needs an earphone to broadcast audio for flexible action, using an external earphone needs additional connection, and it is inconvenient to retrieve the earphone. This problem is presently solved by using a wireless earphone or a built-in earphone on a cellular phone. However, a built-in earphone increases the volume of the cellular phone for accommodating the earphone. When the earphone is not being used in a long period of time, the increased volume is an additional burden for the cellular phone. In addition, even though the wireless earphone and the cellular phone can be disconnected, so the wireless earphone does not add volume to the cellular phone, still does not solve the problem of losing the wireless earphone during retrieving of it.

Accordingly, the primary scope of the invention provides an electronic apparatus providing a double-duty speaker. When the speaker is accommodated on the electronic apparatus, the speaker can serve as a common speaker. When the speaker is pulled out of the electronic apparatus, the speaker can serve as an earphone. This can solve the problem mentioned above.

### SUMMARY OF THE INVENTION

The primary scope of the invention provides an electronic apparatus providing a double-duty speaker.

According to a preferred embodiment, an electronic apparatus includes a casing, an electronic unit, a first speaker, and a second speaker. The casing includes a first recess, a second recess, and a cable-receiving space. The cable-receiving space achieves its function by a cable-winding device. The first speaker includes a first speaker casing and a first speaker hole. The second speaker includes a second speaker casing and a second speaker hole. The shapes of the first speaker casing and the second speaker casing are respectively consistent with the first recess and the second recess. In the preferred embodiment, the shapes are circular shapes, which are the shape of a common earphone. The first speaker is electrically coupled to the electronic unit by a first audio signal transmitting device. The second speaker is electrically coupled to the electronic unit by a second audio signal transmitting device. The electronic unit is installed in the casing, and it can transmit a first audio signal to the first speaker through the first audio signal transmitting device and a second audio signal to the second speaker through the second audio signal transmitting device. The electronic unit is capable of transmitting both the first audio signal and the second audio signal to form a non-single channel effect. The first audio signal transmitting device achieves its function by a first cable. The first cable includes a first end and a second end. The first end is electrically coupled to the first speaker casing; the second end passes through a first formed-through aperture formed on the first recess, and it is engaged to the cable-winding device and electrically coupled to the electronic unit. The second audio signal transmitting device achieves its function by a second cable. The second cable includes a third end and a fourth end. The third end is electrically coupled to the second speaker casing; the fourth end passes through a second formed-through aperture formed on the second recess, and it is engaged to the cable-winding device and electrically coupled to the electronic unit.

Therein, when the first speaker casing is associated with the first recess, and the second speaker casing is associated with the second recess, the first speaker casing is configured to be partially accommodated in the first recess and partially exposed out of the casing so that the first speaker hole is exposed outside the casing; the second speaker casing is configured to be partially accommodated in the second recess and partially exposed out of the casing so that the second speaker hole is exposed outside the casing. The first cable and the second cable are wound and accommodated in the cable-winding device, and the electronic unit outputs the first audio signal initially at a first power through the first speaker and outputs the second audio signal initially at the first power through the second speaker.

Besides, when the first speaker casing is detached from the first recess, and the second speaker casing is detached from the second recess, the first cable and the second cable is operable to be pulled out of the casing and then operable and releasable to be clamped by the cable-winding device. The electronic unit outputs the first audio signal initially at a second power lower than the first power through the first speaker and outputs the second audio signal initially at the second power through the second speaker.

Furthermore, the electronic apparatus includes a switch, which is electrically coupled to the electronic unit and disposed in the casing. The switch is capable of sensing whether the first speaker casing is detached from or is associated with the first recess and/or the second speaker casing is detached from or is associated with the second recess. Thereby, when the first speaker casing is associated with the first recess, and the second speaker casing is associated with the second recess, the switch controls the electronic unit to broadcast the first audio signal and the second audio signal at the first power. When the first speaker casing is detached from the first recess, and the second speaker casing is detached from the second recess, the switch controls the electronic unit to broadcast the first audio signal and the second audio signal at the second power. The switch is also switched on in response to the pulling-out of the first cable and/or the second cable, such that the electronic unit broadcasts the first audio signal and the second audio signal at the second power in response to the switching-on of the switch.

In addition, the casing includes a first edge and a second edge. The first recess is formed on the first edge. The second recess is formed on the second edge. When the first speaker casing is associated with the first recess, and the second speaker casing is associated with the second recess, there is a default distance between the first speaker and the second speaker for enhancing the non-single channel effect.

Therefore, the invention provides an electronic apparatus providing a double-duty speaker. When the speaker is accommodated on the electronic apparatus, the speaker can serve as a common speaker. When the speaker is pulled out of the electronic apparatus, the speaker can serve as an earphone.

The advantage and spirit of the invention may be further understood by the following recitations together with the appended drawings.

### BRIEF DESCRIPTION OF THE APPENDED DRAWINGS

FIG. 1 is an external perspective view of an electronic apparatus according to a first preferred embodiment of the invention.

FIG. 2 is an external perspective view of the electronic apparatus according to the first preferred embodiment of the invention when a first speaker and a second speaker are pulled out of a casing.

FIG. 3 is a partial interior perspective view of the electronic apparatus according to the first preferred embodiment of the invention.

FIG. 4 is a partial blown-up view of the electronic apparatus according to the first preferred embodiment of the invention.

FIG. 5 is an external perspective view of an electronic apparatus according to a third preferred embodiment of the invention.

### DETAILED DESCRIPTION OF THE INVENTION

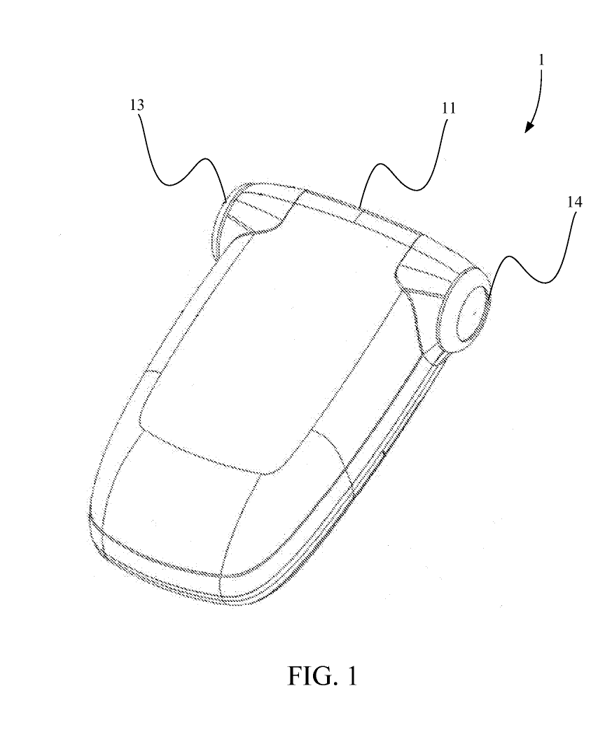

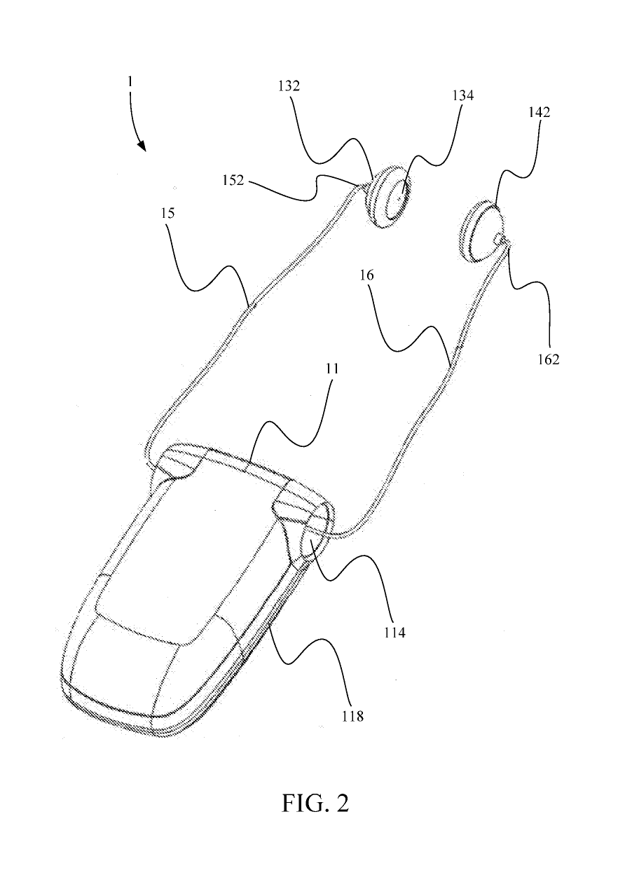

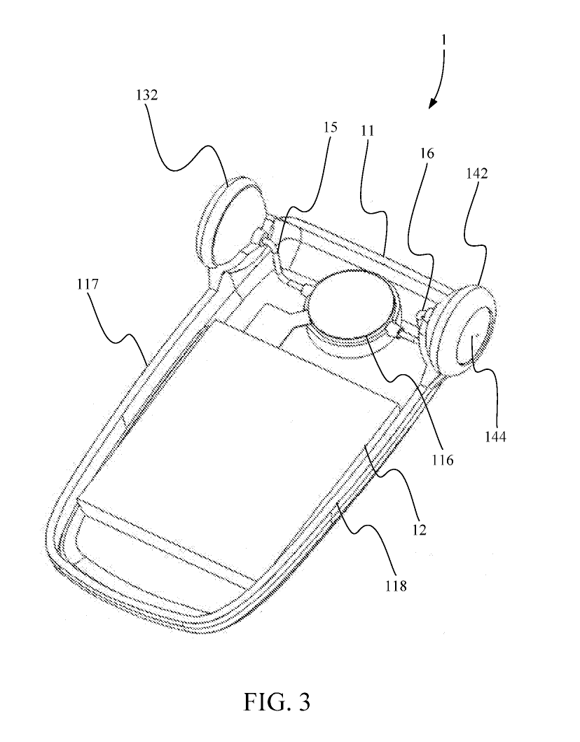

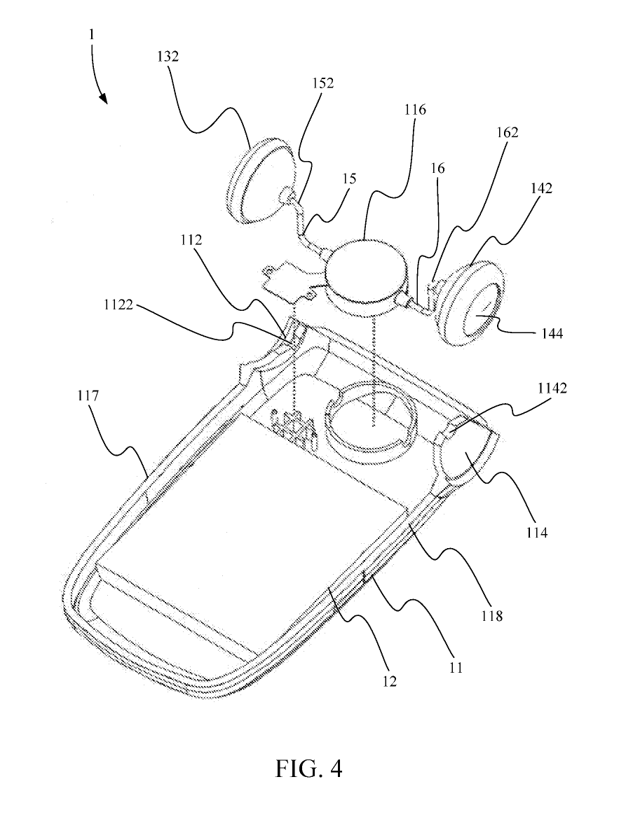

Referring to FIG. 1 to FIG. 4, FIG. 1 is an external perspective view of an electronic apparatus 1 according to a first preferred embodiment of the invention. FIG. 2 is an external perspective view of the electronic apparatus 1 according to the first preferred embodiment of the invention when a first speaker 13 and a second speaker 14 are pulled out of a casing 11. FIG. 3 is a partial interior perspective view of the electronic apparatus 1 according to the first preferred embodiment of the invention. FIG. 4 is a partial blown-up view of the electronic apparatus 1 according to the first preferred embodiment of the invention. According to the first preferred embodiment, the electronic apparatus 1 includes the casing 11, an electronic unit 12, the first speaker 13, and the second speaker 14. The casing 11 includes a first recess 112, a second recess 114, and a cable-receiving space 116. According to the first preferred embodiment, the cable-receiving space 116 achieves its function by a cable-winding device 116, which can also be replaced by other device with accommodation function. The first speaker 13 includes a first speaker casing 132 and a first speaker hole 134. The second speaker 14 includes a second speaker casing 142 and a second speaker hole 144. The shapes of the first speaker casing 132 and the second speaker casing 142 are respectively consistent with the first recess 112 and the second recess 114. In the first preferred embodiment, the shapes are circular shapes, which are the shape of a common earphone. The first speaker 13 is electrically coupled to the electronic unit 12 through a first audio signal transmitting device 15. The first speaker 14 is electrically coupled to the electronic unit 12 through a second signal transmitting device 16. The electronic unit 12 is disposed in the casing 11. The electronic unit 12 can transmit a first audio signal to the first speaker 13 through the first audio signal transmitting device 15 and a second audio signal to the second speaker 14 through the second audio signal transmitting device 16. The electronic unit 12 is capable of outputting both the first audio signal and the second audio signal to form a non-single channel effect. The first audio signal transmitting device achieves its function by a first cable 15. The first cable includes a first end 152 and a second end (not shown in the figures). The first end 152 is electrically coupled to the first speaker casing 132; the second end passes through a first formed-through hole 1122 formed on the first recess 112, and it is engaged to the cable-winding device 116 and electrically coupled to the electronic unit 12. The second audio signal transmitting device 16 achieves its function by a second cable 16. The second cable 16 includes a third end 162 and a fourth end (not shown in the figures). The third end 162 is electrically coupled to the second speaker casing 142; the fourth end passes through a second formed-through aperture 1142 formed on the second recess 114, and it is engaged to the cable-winding device 116 and electrically coupled to the electronic unit 12.

Therein, when the first speaker casing 132 is associated with the first recess 112, and the second speaker casing 142 is associated with the second recess 114, the first speaker casing 132 is configured to be partially accommodated in the first recess 112 and partially exposed outside the casing 11 so that the first speaker hole 134 is exposed outside the casing 11; the second speaker casing 142 is configured to be partially accommodated in the second recess 114 and partially exposed outside the casing 11 so that the second speaker hole 144 is exposed outside the casing 11. The first cable 15 and the second cable 16 are wound and accommodated in the cable-winding device 116, and the electronic unit 12 outputs the first audio signal initially at a first power through the first speaker 13 and outputs the second audio signal initially at the first power through the second speaker 14.

Besides, when the first speaker casing 132 is detached from the first recess 112, and the second speaker casing 142 is detached from the second recess 114, the first cable 15 and the second cable 16 is operable to be pulled out of the casing 11 and then operable and releasable to be clamped by the cable-winding device 116. The electronic unit 12 outputs the first audio signal initially at a second power lower than the first power through the first speaker 13 and outputs the second audio signal initially at the second power through the second speaker 14.

Furthermore, the electronic apparatus 1 includes a switch (not shown in the figures), which is electrically coupled to the electronic unit 12 and disposed in the casing 11. The switch is capable of sensing whether the first speaker casing 132 is detached from or is associated with the first recess 112, and/or the second speaker casing 142 is detached from or is associated with the second recess 114. Thereby, when the first speaker casing 132 is associated with the first recess 112, and the second speaker casing 142 is associated with the second recess 114, the switch controls the electronic unit 12 to broadcast the first audio signal and the second audio signal at the first power. When the first speaker casing 132 is detached from the first recess 112, and the second speaker casing 142 is detached from the second recess 114, the switch controls the electronic unit 12 to broadcast the first audio signal and the second audio signal at the second power. The switch is also switched turned on in response to the pulling-out of the first cable 15 and/or the second cable 16, such that the electronic unit 12 broadcasts the first audio signal and the second audio signal at the second power in response to the switching-on of the switch.

In addition, the casing 11 includes a first edge 117 and a second edge 118. The first recess 112 is formed on the first edge 117. The second recess 114 is formed on the second edge 118. When the first speaker casing 132 is associated with the first recess 112, and the second speaker casing 142 is associated with the second recess 114, there is a default distance between the first speaker 13 and the second speaker 14 for enhancing the non-single channel effect.

In another second preferred embodiment, comparing with the first preferred embodiment, an electronic apparatus of the second preferred embodiment includes a first cable-winding device and a second cable-winding device. The first cable can selectively be released or clamped by the first cable-winding device. The second cable is capable of selectively being released or clamped by the second cable-winding device. Besides, the first cable-winding device and the second cable-winding device can be independently operated.

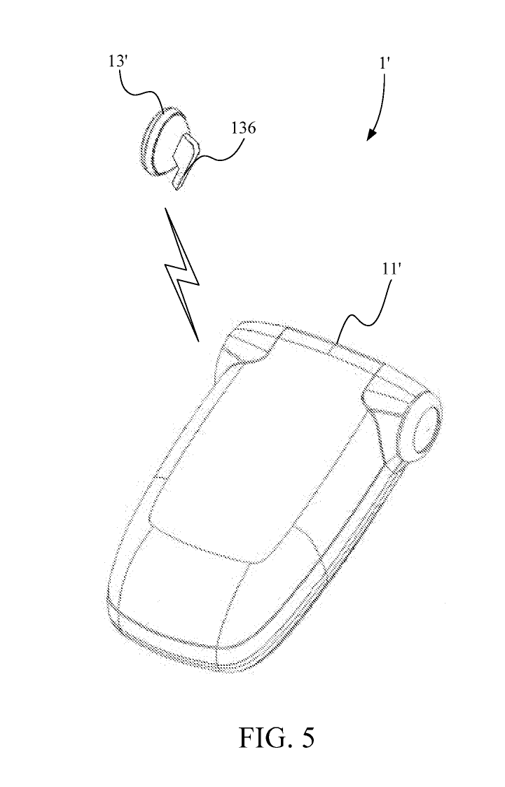

In another third preferred embodiment, comparing with the first preferred embodiment, an electronic apparatus 1′ of the third preferred embodiment includes a first audio signal transmitting device (not shown in FIG. 5) and a first speaker 13′. The first audio signal transmitting device includes a bluetooth transmitter (not shown in FIG. 5) disposed in the casing 11′. The first speaker 13′ includes a bluetooth receiver 136. The bluetooth transmitter and the bluetooth receiver 136 transmit a first audio signal in a wireless way, as shown in FIG. 5.

Therefore, the invention provides an electronic apparatus providing a double-duty speaker. When the speaker is accommodated on the electronic apparatus, the speaker can serve as a common speaker. When the speaker is pulled out of the electronic apparatus, the speaker can serve as an earphone. The invention can be applied to communication apparatus, such as the cellular phone in the preferred embodiments, and it can also be applied to portable computers or desktop computers, which all effectively exploit the functions of the invention.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. An electronic apparatus, comprising:
a casing, thereon providing a first recess and a second recess, the first recess comprising a first formed-through aperture, the second recess comprising a second formed-through aperture;
an electronic unit, disposed in the casing;
a cable-winding device, disposed in the casing;
a first speaker, comprising a first speaker casing and a first cable, the first speaker casing being configured to be partially accommodated in the first recess and partially exposed outside the casing, the first cable comprising a first end and a second end, the first end being electrically coupled to the first speaker casing, the second end passing through the first formed-through aperture, being engaged to the cable-winding device, and being electrically coupled to the electronic unit; and
a second speaker, comprising a second speaker casing and a second cable, the second speaker casing being configured to be partially accommodated in the second recess and partially exposed outside the casing, the second cable comprising a third end and a fourth end, the third end being electrically coupled to the second speaker casing, the fourth end passing through the second formed-through aperture, being engaged to the cable-winding device, and being electrically coupled to the electronic unit
wherein the first cable and the second cable are operable to be pulled out of the casing and then operable and releasable to be clamped by the cable-winding device, and after the first cable and the second cable clamped by the cable-winding device are released by the cable-winding device, the cable-winding device winds the first cable and the second cable.

2. The electronic apparatus of claim 1, wherein when the first speaker body is associated with the first recess and the second speaker body is associated with the second recess, the electronic unit is capable of broadcasting an audio signal initially at a first default power through the first speaker body and the second speaker body.

3. The electronic apparatus of claim 2, further comprising a switch electrically coupled to the electronic unit and disposed in the casing such that the switch is switched on in response to the pulling-out of the first cable and/or the second cable, wherein the electronic unit is capable of broadcasting, responsive to the switching-on of the switch, the audio signal initially at second default power lower than the first default power through the first speaker body and the second speaker body.

4. The electronic apparatus of claim 1, wherein the casing has a first edge and a second edge, the first recess is formed on the first edge, and the second recess is formed on the second edge.

5. An electronic apparatus, comprising:
a casing, comprising a first recess and a cable-receiving space;
an electronic unit, disposed in the casing, for outputting a first audio signal;
a first speaker, comprising a first speaker casing and a first speaker hole; and
a first audio signal transmitting device, electrically coupled to and between the first speaker and the electronic unit, the first audio signal transmitting device transmitting the first audio signal to the first speaker, the cable-receiving space being capable of accommodating the first audio signal transmitting device;
wherein when the first speaker casing is detached from the first recess, the first audio signal transmitting device is electrically coupled to the first speaker and transmits the first audio signal to the first speaker, and when the first speaker casing is associated with the first recess, the first speaker hole is exposed outside the casing such that the first speaker outputs the first audio signal without being obstructed by the casing.

6. The electronic apparatus of claim 5, wherein when the first speaker casing is associated with the first recess, the electronic unit broadcasts the first audio signal at a first power, and when the first speaker casing is detached from the first recess, the electronic unit broadcasts the first audio signal at a second power, and the second power is lower than the first power.

7. The electronic apparatus of claim 6, further comprising a switch electrically coupled to the electronic unit, the switch being capable of sensing whether the first speaker casing is detached from or is associated with the first recess, wherein when the first speaker casing is associated with the first recess, the switch controls the electronic unit to broadcast the first audio signal at the first power, and when the first speaker casing is detached from the first recess, the switch controls the electronic unit to broadcast the audio signal at the second power.

8. The electronic apparatus of claim 5, further comprising:
a second speaker, comprising a second speaker casing and a second speaker hole, wherein the electronic unit also outputs a second audio signal; and
a second audio signal transmitting device, electrically coupled to and between the second speaker and the electronic unit, the second audio signal transmitting device transmitting the second audio signal to the second speaker;
wherein the casing also comprises a second recess, when the second speaker casing is detached from the second recess, the second audio transmitting device is capable of being pulled out of the casing, and when the second speaker casing is associated with the second recess, the second audio signal transmitting device is accommodated in the cable-receiving space, and the second speaker hole is exposed outside the casing.

9. The electronic apparatus of claim 8, wherein the first audio signal is different from the second audio signal, and the electronic unit outputs both the first audio signal and the second signal to form a non-single channel effect.

10. The electronic apparatus of claim 9, wherein the casing comprises a first edge and a second edge, the first recess is formed on the first edge, the second recess is formed on the second edge, and when the first speaker casing is associated with the first recess, and the second speaker casing is associated with the second recess, there is a default distance between the first speaker and the second speaker for enhancing the non-single channel effect.

11. The electronic apparatus of claim 5, wherein the first audio signal transmitting device is a first cable, when the first speaker casing is detached from the first recess, the first cable is capable of being pulled out of the casing, and when the first speaker casing is associated with the first recess, the first cable is accommodated in the cable-receiving space.

12. The electronic apparatus of claim 11, further comprising:
a second speaker, comprising a second speaker casing and a second speaker hole; and
a second cable, electrically coupled to and between the second speaker and the electronic unit;
wherein the casing also comprises a second recess, when the second speaker casing is detached from the second recess, the second cable is capable of being pulled out of the casing, and when the second speaker casing is associated with the second recess, the second cable is accommodated in the cable-receiving space.

13. The electronic apparatus of claim 12, further comprising a first cable-winding device, the first cable being capable of being selectively released or clamped by the first cable-winding device.

14. The electronic apparatus of claim 13, further comprising a second cable-winding device, the second cable being capable of being selectively released or clamped by the second cable-winding device, the first cable-winding device and the second cable-winding device being capable of independently winding.

15. The electronic apparatus of claim 5, wherein the first speaker casing is circular, and the first speaker casing is capable of being disposed in an ear of a user to serve as an ear phone.

16. The electronic apparatus of claim 15, wherein the first recess is circular and is capable of being tight associated with the first speaker casing.

17. The electronic apparatus of claim 5, wherein the first audio signal transmitting device comprises a bluetooth transmitter, the first speaker comprises a bluetooth receiver, and the bluetooth transmitter and the bluetooth receiver transmit the first audio signal in a wireless way.

18. The electronic apparatus of claim 9, wherein the first recess and the second recess are respectively formed on a left side of the casing and a right side of the casing, and when the first speaker casing is associated with the first recess, and the second speaker casing is associated with the second recess, the first speaker and the second speaker respectively outputs a left channel of the first audio signal and a right channel of the first audio signal.
